(19) United States
(12) Patent Application Publication
(10) Pub. No.: US 2002/0178053 A1
(43) Pub. Date: Nov. 28, 2002

(54) Electronic commerce method and system for offering discounts for access to a computer network

(76) Inventors: Robert W. Eaker, Oceanside, CA (US); Robert A. Rango, Newport Coast, CA (US); Walter G. Soto, Irvine, CA (US); Gerard J. Papa, Redondo Beach, CA (US)

Correspondence Address: MANELLI DENISON & SELTER PLLC, 2000 M Street, N.W., 7th Floor, Washington, DC, 20036-3307, US

(21) Appl. No.: 09/861,588

(22) Filed: May 22, 2001

(51) Int. Cl. G06F 17/60

(52) U.S. Cl. 705/14

(57) ABSTRACT

A method, system and apparatus for providing discounted access to a computer network. The present invention takes advantage of the unique position of a service provider between a business on a computer network and an end user. The service provider compiles informative profiles of its end users in a customer database. Limited access to this customer database is then used to attract businesses. The business provides information about the end users it is interested to the service provider. The true identities of the service provider's end users is kept private from the business. The business prepares an advertisement which the service provider will send to its end users. The service provider then makes the end users aware of the business via an e-mail with short text describing that offer and a hypertext link. As a service, the service provider will only provide the true identity and information of an end user to a business when authorized. In exchange for authorizing the release of their true identity and information, the service provider compensates the end user through discounted (or free) access charges on access path to a network such as the Internet.

### BACKGROUND OF THE INVENTION

1. Field of the Invention

This invention relates generally to electronic commerce using the Internet. More particularly, it relates to apparatus and methods of offering discounts to users based on their access speed, e.g., digital subscriber line, cable modem, etc.

2. Background of Related Art

Today, electronic commerce via the Internet, e.g., advertising and retailing, has become popular. Electronic commerce via the Internet allows businesses to disseminate information about their products or services quickly and inexpensively. Electronic commerce via the Internet also allows businesses to collect information about their users so that they can identify interest in their products or services.

FIG. 3 shows a conventional topology for electronic commerce systems used by businesses.

In particular, as shown in FIG. 3, an end user 301 is connected to a service provider 302 via access path 303. The service provider 302 is coupled to the Internet 304. Businesses 305 and 307 are also coupled to the Internet 304. Businesses 305 and 307 maintain separate customer databases 306 and 308 to track consumer interest in their respective products or services.

FIG. 4 shows a conventional process for electronic commerce.

In particular, as shown in FIG. 4, in step 401 a user searches for a product or service which interests him/her. For example, a user may search for the product or service by browsing on the Internet 304.

In step 402, businesses 305 and 307 display to the user an advertisement. For example, the display of a “banner” advertisement or “pop up” screen to a user browsing on the Internet 304 is known.

The advertisement may also include an incentive. For example, an incentive, e.g., a coupon which provides a discount on the purchase of a product is known.

In step 403, the user demonstrates interest in the advertisement. For example, the user may “click” on a particular “banner” advertisement.

In step 404, the user is asked to provide information in exchange for receiving the incentive, e.g., a coupon or free sample. For example, the information requested may include name, address, and credit card number.

In step 405, businesses 305 and 307 collect the information from the user and compile it in their respective databases 306 and 308.

Typically, businesses 305 and 307 use their databases 306 and 308 to develop marketing and identify other users who might be interested in their products or services.

Unfortunately, even some users who might be interested in a particular product or service are reluctant to provide information to businesses over the Internet. Incidents of fraud have become prevalent where users' identities were stolen by unscrupulous parties or sold by the business in which they were dealing. Consequently, many users are reluctant to provide information about themselves to anyone over the Internet.

To overcome user reluctance, some businesses have developed a user privacy policy which may include requesting permission prior to releasing a user's information.

However, even users who might be willing to share their private information with a reputable business are reluctant to provide their private information to multiple parties and/or businesses. Consequently, many businesses still have difficulty in obtaining information directly from their customers. Thus, there is a need to protect user privacy in the presence of multiple parties and/or businesses.

Growing demand for access to the Internet has led also to increasing interest in higher speed broadband connections such as cable modems and digital subscriber lines. Today, a typical way to access network resources is via dial-up connections using analog dial modems.

The advent of digital subscriber line (“DSL”) services and cable modems has enabled Internet Service Providers promising ways to offer customers higher speed access to the Internet.

DSL is a copper loop transmission technology which utilizes the existing voice telephony copper (i.e., telephone line), but delivers a higher information rate than analog dial-up technology. Cable modems are a coaxial cable transmission technology which utilizes the existing cable television infrastructure to deliver a higher information rate than analog dial-up technology.

However, analog dial-up technology is inexpensive. As a result, demand for DSL and cable modems is hurt since both are currently more expensive than analog dial-up technology.

Thus there is also a need to offer higher speed access technologies such as DSL and cable modems at a competitive price to analog dial-up technology.

### SUMMARY OF THE INVENTION

In accordance with the principles of the present invention, a method for providing discounted access to a computer network, comprises compiling user attribute information of a user accessing a computer network; offering the user a discount on the access charges to the computer network in exchange for a release authorization; and releasing the user's attribute information only when authorized by the user.

In accordance with another aspect of the present invention, a system for providing discounted access to a computer network, comprises: an access path to a computer network for a user; a database for compiling user attribute information; an authorization processor for communicating authorization requests to release the user attribute information; and a discount processor for calculating a user's discount for charges on the access path.

In accordance with another aspect of the present invention, an apparatus for providing access to a computer network, comprises: means for compiling user attribute information of a user accessing a computer network; means for offering the user a discount on access charges to the computer network in exchange for a release authorization; and means for releasing the attribute information of when authorized by the user.

### BRIEF DESCRIPTION OF THE DRAWINGS

Features and advantages of the present invention will become apparent to those skilled in the art from the following description with reference to the drawings, in which:

FIG. 1 shows an exemplary topology and electronic commerce system for offering discounts on access to a computer network, in accordance with the principles of the present invention.

FIG. 2 shows an exemplary process for offering discounts on access to a computer network, in accordance with the principles of the present invention.

FIG. 3 shows a conventional topology for electronic commerce systems.

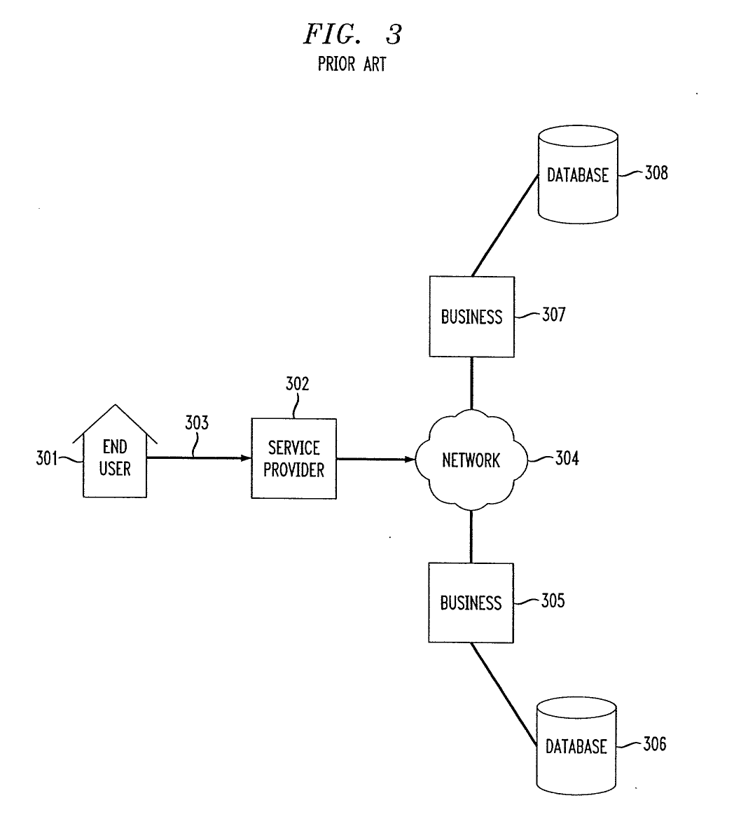

FIG. 4. shows a conventional process for electronic commerce.

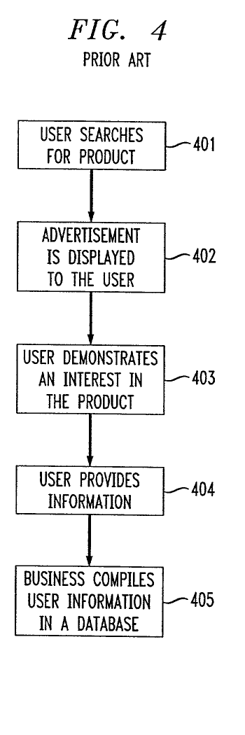

### DETAILED DESCRIPTION OF ILLUSTRATIVE EMBODIMENTS

In accordance with the principles of the present invention, a service provider (e.g., an Internet Service Provider or “ISP”) can take advantage of its unique knowledge of its customer base to increase demand for high speed access, e.g., DSL, cable modems, etc. with respect to both customers identity and their likes and dislikes, while preserving the privacy of those customers. In addition, customers may be offered discounted (or free) high speed Internet access.

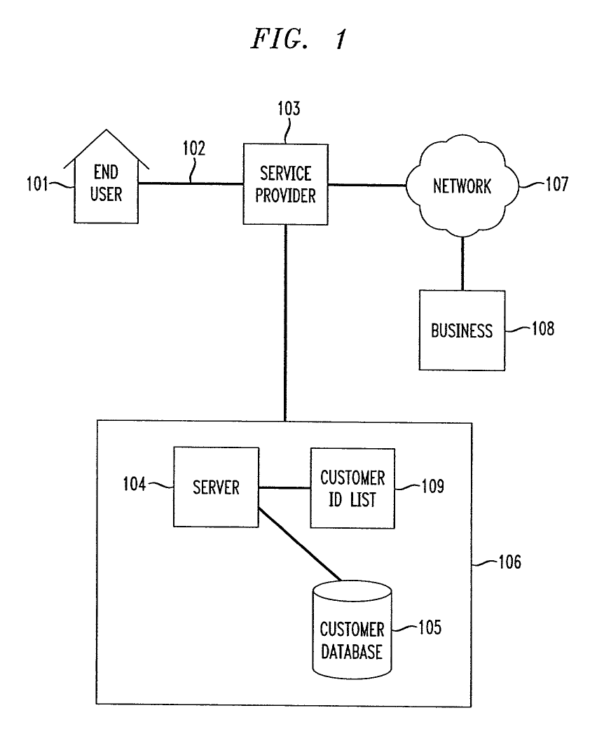

FIG. 1 shows an exemplary topology and electronic commerce system to offer discounts on access to a computer network, in accordance with the principles of the present invention.

In particular, as shown in FIG. 1, an end user 101 is coupled to the service provider 103 via an access path 102. Preferably, the access path 102 is via a cable modem or a digital subscriber line. However, any broadband access path technology is within the principles of the present invention.

The service provider 103 is coupled to a network 107. Business 108 is coupled also to network 107. The service provider 103 and business 108 may be coupled to the network 107 by a wide variety of ways. Preferably, network 107 is the Internet. However, any wide area network which is coupled to different multiple parties is in accordance with the principles of the present invention.

The service provider 103 maintains an electronic commerce system 106. The electronic commerce system 106 further includes a server 104, a customer database 105 and a customer identity list 109. The server 104 is coupled to the customer database 105 and customer identity list 109.

The server 104 compiles customer information about end user 101, controls release authorizations and calculates end user compensation.

The server 104 compiles information either directly or indirectly from end user 101 to create an informative profile in customer database 105. For example, the service provider 103 may request that the end user 101 provide a name, phone number, address, and other personal information. Preferably, information provided by the end user 101 may include access path information, i.e., cable modem or digital subscriber line, as well as personal computer information such as processor type, processor speed, and memory. The server may also track websites visited such as retail websites and news websites.

The server 104 maintains controls over the release authorizations by keeping the identity of each end user 101 anonymous. The customer database 105 is maintained separately from customer identity list 109. The customer identity list 109 may include name, address, phone number, and email. Only the server 104 has the ability to correlate customer database profiles stored in the customer database 105 to the true identity of the end user 101 in the customer identity list 109. The server 104 may correlate the profiles in a wide variety of ways. Preferably, an end user's identity is encoded within the customer database 105 which appears in decoded format only in customer identity list 109. However, any technique which can maintain an end user's true identity anonymous in the customer database 105 is within the principles of the present invention.

The server 104 also controls the privacy of the customer database 105 by allowing only trusted businesses, e.g., business 108 access to the customer database 105. The service provider 103 does not allow uncontrolled access to the customer identity list 109.

In accordance with the principles of the present invention, the service provider 103 not the business 108 maintains and/or owns the user database. By maintaining and/or owning the database, the service provider 103 is able to guarantee the conduct of businesses, i.e., business 108. The present invention allows the end user 101 to disclose his/her private information to a trusted third party, i.e., the server provider 103. The present invention enables the user to avoid disclosing his/her private information multiple times to multiple businesses. Also, the present invention allows business 108 to avoid having to maintain and/or collect customer information on its own. Instead, business 108 may rely upon the unique information that service provider 103 can obtain about its customer base.

The server 104 may calculate end user compensation based upon a wide variety of attributes, such as the total number of release authorizations received from a particular end user, an end user's access type, i.e., cable modem or DSL, or an end user's personal computer specifications. Preferably, the service provider 103 compensates the end user 101 through discounted access charges on access path 102 based upon the number of release authorization received, the customer's access type, or the customer's personal computer specifications, e.g., processor speed. However, any compensation scheme in which the service provider 103 directly compensates an end user is within the principles of the present invention.

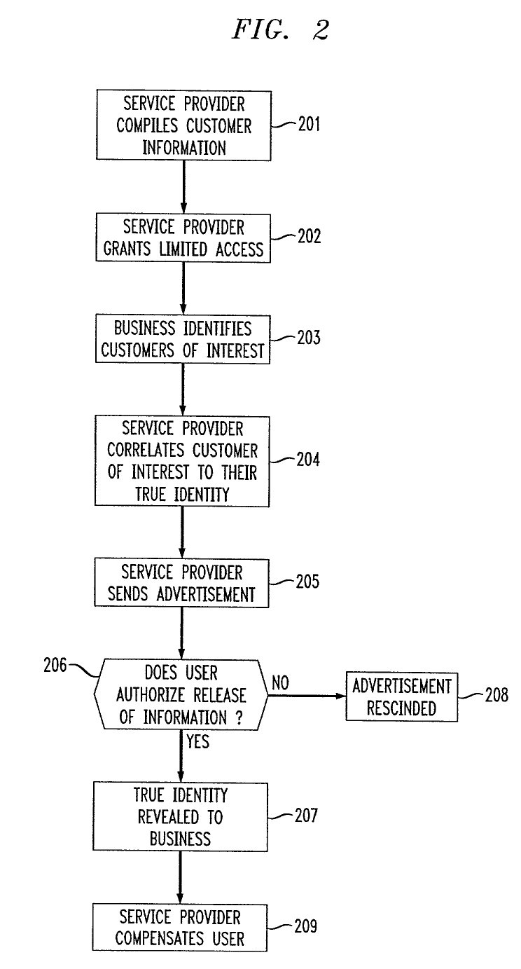

FIG. 2 shows an exemplary process for offering discounts on access to a computer network, in accordance with the principles of the present invention.

In particular, as shown in FIG. 2, in step 201 the service provider 103 compiles information directly and indirectly from the end user 101 to create an informative profile. For example, the service provider 103 may request that the end user 101 provide a name, phone number, address, and other personal information. Information requested may include access path information, i.e., cable modem or digital subscriber line, as well as personal computer information such as processor type, processor speed, and memory.

The service provider 103 may also obtain information indirectly by tracking websites visited such as retail websites and news websites. Tracking websites visited may be performed in wide variety of ways.

Preferably, the service provider 103 uses a combination of direct information obtained from the end user 101 with indirect information obtained by tracking websites visited by the end user 101. However, any information which aids in compiling an informative profile is in accordance with the principles of the present invention.

In step 202, the service provider 103 grants limited access to business 108 to the customer database 105. The service provider 103 maintains the privacy of end user 101 by allowing only trusted businesses access to the customer database 105 and withholding access to the customer identity list 109. Preferably, sufficient access to identify customers which may be interested in a business' products or services based on their profile is granted.

In step 203, the business 108 provides the service provider 103 a list of customers of interest. Preferably, the business 108 provides a list of encoded names. However, any information that describes a particular group of customers which the business 108 is interested is in accordance with the principles of the present invention.

In step 204, the service provider 103 correlates the list of customers of interest to the true identities of its end users. Preferably, the service provider 103 correlates the customer names in customer database 105 to true identities stored in the customer identity list 109.

In step 205, the service provider 103 sends an advertisement to the end users identified in step 204. The advertisements can be in a wide variety of formats such as coupons, discounts, contests, or links to a website.

Only the service provider 103 notifies the end user 101 of the advertisement. This prevents an end user's true identity from becoming available to the public at large. In addition, the service provider 103 can certify to its end users that the businesses are legitimate or that the advertisements sent by the service provider 103 are legitimate. In addition, the service provider 103 could require the business agree not to resell any customer information it receives in exchange for access to the customer database 105.

Notification of the end user 101 of an advertisement may be performed by a wide variety of means in accordance with the principles of the present invention. Preferably, the advertisement comprises an e-mail with a short description and hypertext links.

A release authorization statement may also included with the notification of the offer. The release authorization sets forth the terms by which the customer allows the release of his/her information. The release authorization statement may be in a wide variety of forms, such as a file attachment, or an embedded hypertext link. Preferably, the release authorization statement is included as a hypertext link which the end user 101 may “click” to read in detail.

In step 206, the end user 101 decides whether to release his/her information. An end user's 101 true identity may be disclosed to the business 108 only when the customer authorizes a release.

In step 208, the end user 101 decides not to send an authorization release. The end user 101 may decline the release authorization by a wide variety of ways. For example, the end user 101 could “click” a hypertext link, e.g., “decline” or respond with an email. Preferably, the user's decline of a release authorization is sent when the end user “clicks” on a particular hypertext link.

In response to the end user 101 declining the advertisement, the service provider 103 may note the end user's decision in the customer database 105 and rescinds the advertisement.

In step 207, if authorized by the end user 101, the service provider 103 may release the true identity and information of the end user 101 to the business 108 and compensate the end user 101. A release authorization may be sent by a wide variety of ways. For example, the end user 101 could “click” a hypertext link, e.g., “authorize release” or respond with an email. Preferably, the release authorization is sent when the end user “clicks” a hypertext link.

In response to receiving a release authorization, the service provider 103 may release the end user's 101 true identity from the customer identity list 109. The service provider 103 may notify the business 108 in a wide variety of ways. For example, the service provider 103 may send an email to business 108 disclosing the end user's true identity and information. Preferably, the service provider 103 generates a report which is sent to the business 108 listing the true identities and profiles of the end users who have authorized the release of their information. The business is then allowed to deal with the end user directly.

In step 209, the service provider 103 compensates the end user 101 through discounted (or free) access charges on access path 102.

By receiving compensation directly from the service provider 103, the effective cost of services like cable modems and DSL is reduced. Preferably, the service provider 103 is able to discount access services such as cable modems and DSL comparable to the price of analog dial services. Thus, the present invention allows for service providers to maintain privacy and increase the demand for traditionally more expensive access services such as cable modem and DSL.

While the invention has been described with reference to the exemplary embodiments thereof, those skilled in the art will be able to make various modifications to the described embodiments of the invention without departing from the true spirit and scope of the invention.

What is claimed is:

1. A method for providing discounted access to a computer network, comprising:
compiling user attribute information of a user accessing a computer network;
offering said user a discount on said user's access charges to said computer network in exchange for a release authorization of said user's attributes; and
releasing said user attribute information of said user when authorized by said user.

2. The method of claim 1, further comprising:
discounting said user's access charges to said computer network upon receiving said release authorization.

3. The method of claim 1, wherein:
said attribute information of said user includes access type information.

4. The method of claim 3, wherein:
said access type information describes a cable modem.

5. The method of claim 3, wherein:
said access type information describes a digital subscriber line.

6. The method of claim 1, wherein:
said attribute information of said user includes personal computer attribute information.

7. The method of claim 6, wherein:
said personal computer attribute information includes processor type.

8. The method of claim 6, wherein:
said personal computer attribute information includes processor speed.

9. The method of claim 1, wherein:
said discount is based upon the amount of time said user accesses said computer network.

10. The method of claim 1, wherein:
said user authorizes said release of said user's attribute information by selecting a hypertext link.

11. The method of claim 1, wherein:
said user attribute information includes a history of network sites accessed by said user.

12. The method of claim 1, wherein:
said user attribute information includes demographic information.

13. A system for providing discounted access to a computer network, comprising:
an access path to a computer network;
a database for compiling user attribute information;
an authorization processing routine for communicating authorization requests to release said user attribute information; and
a discount processing routine for calculating a user's discount on said access path.

14. The system of claim 13, wherein:
said access path to said computer network is via a cable.

15. The system of claim 13, wherein:
said access path to said computer network is a digital subscriber line.

16. The system of claim 13, wherein:
said user attribute information includes personal computer information.

17. The system of claim 16, wherein:
said personal computer information includes processor type.

18. The system of claim 16, wherein:
said personal computer information includes processor speed.

19. The system of claim 13, wherein:
said user attribute information includes access type information.

20. The system of claim 19, wherein:
said access type information describes a cable modem.

21. The system of claim 19, wherein:
said access type information describes a digital subscriber line.

22. An apparatus for providing access to a computer network, comprising:
means for compiling user attribute information of a user accessing a computer network;
means for offering said user a discount on said user's access charges to said computer network in exchange for a release authorization of said user's attributes; and
means for releasing the attribute information of said user when authorized by said user.

23. The apparatus of claim 22 further comprising:
means for discounting said user's access charges to said computer network upon receiving said release authorization.
